(19) United States
(12) Patent Application Publication
(10) Pub. No.: US 2024/0199920 A1
(43) Pub. Date: Jun. 20, 2024

(54) ARTICLES CONTAINING ADHESIVE COMPOSITIONS EXHIBITING ON-DEMAND DEBONDING BEHAVIOR

(71) Applicant: 3M INNOVATIVE PROPERTIES COMPANY, St.Paul, MN (US)

(72) Inventors: Aaron T. Hedegaard, Woodbury, MN (US); Jason D. Clapper, Lino Lakes, MN (US); Eric J. Olson, Prior Lake, MN (US); Lindsey Hines, Stillwater, MN (US); Ken Kawamoto, St. Paul, MN (US); Ross E. Behling, Woodbury, MN (US); Kevin D. Hagen, St.Paul, MN (US); Mahfuza B. Ali, Mendota Heights, MN (US)

(21) Appl. No.: 18/564,654

(22) PCT Filed: May 13, 2022
(86) PCT No.: PCT/IB2022/054477

§ 371 Date: Nov. 28, 2023

Related U.S. Application Data
(60) Provisional application No. 63/202,302, filed on Jun. 4, 2021.

(51) Int. Cl. C09J 7/26; C09J 4/00; C09J 7/38

(52) U.S. Cl. CPC C09J 7/26; C09J 4/00; C09J 7/38; C09J 2301/1242; C09J 2301/302; C09J 2301/502

(57) ABSTRACT

An article comprising a first component having a first electrically conductive surface and a second component having a second surface. An adhesive composition comprising a cured polymerizable ionic liquid is disposed between the first electrically conductive surface and second surface and joins the first component to the second component. The polymerizable ionic liquid comprises an acid functional monomer and the conjugate acid of an imidazole compound. The effort required to separate the first component from the second component, as measured by work of adhesion per surface area, is reduced by application of a DC electric potential across the adhesive composition.

### FIELD OF INVENTION

The present invention relates broadly to articles containing two or more components joined together by an adhesive exhibiting on-demand debonding behavior, more particularly articles that can be separated into two or more components by application of an electric potential across the adhesive.

### BACKGROUND

Adhesives, including pressure-sensitive adhesives (PSAs), are commonly used to bond parts to assembled articles in a variety of industries, including the electronics, automobile, acrospace, abrasive, medical device, and packaging industries. The bond strength of the adhesive between components in an article is critical to achieving the desired performance characteristic for a particular application. In many applications, the adhesive must exhibit a high peel strength to prevent separation or debonding of components during use. For example, an adhesive may be used in the automobile industry to bond trim to the side of a car or truck. In other applications, the adhesive must be reworkable or repositionable. Typically, PSAs adhere more strongly to one component than to another component, thus allowing repositioning or replacement of the component to which the adhesive more strongly adheres. For example, PSAs may be used to bond a protective cover to an electronic device, such as a cellular phone, a personal computer or a computer tablet. Due to the high cost of the articles and relatively low cost of the protective cover, it is sometimes desirable to remove the cover (debond it) for repair of the article, for modification of the article, for repositioning of the backing on the article, or for recycling of the bonded article.

### SUMMARY

A need exists for articles containing adhesive compositions where it is possible to control the timing of debonding, as well as influence the surface from which the adhesive debonds. The present disclosure provides articles comprising two or more components bonded together by an adhesive composition exhibiting on-demand debonding behavior via the application of a direct current (DC) electric potential, and methods for separating the components. The surface from which the adhesive composition debonds can be influenced by the direction of the electric potential across the adhesive composition. The articles and methods described herein can be used in, for example, advanced manufacturing (e.g., to grip a part, transfer the part to another location, and release the part on demand), device maintenance (e.g., to debond an adhesively secured access panel), and/or recycling for economic or environmental benefits (e.g., to separate components that require different recycling processes).

In one embodiment, the present disclosure provides an article comprising:
a first component having a first electrically conductive surface:
a second component having a second surface; and an adhesive composition disposed between the first electrically conductive surface and the second surface, the adhesive composition comprising a cured polymerizable ionic liquid, wherein the adhesive composition joins the first component to the second component, wherein the effort required to separate the first component from the second component, as measured by work of adhesion per surface area, is reduced by application of a DC electric potential across the adhesive composition, and
wherein the polymerizable ionic liquid comprises
a polymerizable anion and a cation corresponding to the conjugate acid of the imidazole compound of Formula I

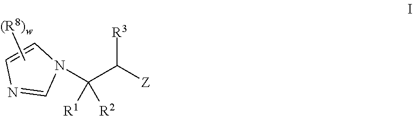

wherein
Z comprises a ketone, ester, amide, nitrile, or azlactone functional group,
R¹ is H or a C₁-C₂₅ alkyl group,
R² is H or —CO—X¹-R⁵, where R⁵ is a H or a C₁-C₂₅ alkyl group and X¹ is —O— or —NR⁶—, where R⁶ is H or a C₁-C₆ alkyl,
R³ is H or CH₃, preferably H, and
R⁸ is a (hetero)hydrocarbyl group which may be substituted at the 2-, 4- or 5-position, and w is 0, 1, 2 or 3,
with the proviso that when Z comprises a nitrile or azlactone functional group, then R¹ and R² are H.

In another embodiment, the present disclosure provides a method for separating components in the article, the method comprising applying the DC electric potential across the adhesive composition to separate the first component from the second component.

As used herein, the term “adhesive composition” means an adhesive or composite (e.g., single- or double-sided tape) that comprises a cured polymerizable ionic liquid that exhibits on-demand debonding behavior when subjected to a DC electric potential.

As used herein, the term “polymerizable ionic liquid” means a composition comprising
a polymerizable anion and a cation corresponding to the conjugate acid of the imidazole compound of Formula I

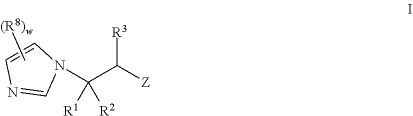

wherein
Z comprises a ketone, ester, amide, nitrile, or azlactone functional group,
R¹ is H or a C₁-C₂₅ alkyl group,
R² is H or —CO—X¹-R⁵, where R⁵ is a H or a C₁-C₂₅ alkyl group and X¹ is —O— or —NR⁶—, where R⁶ is H or a C₁-C₆ alkyl,
R³ is H or CH₃, preferably H, and
R⁸ is a (hetero)hydrocarbyl group which may be substituted at the 2-, 4- or 5-position, and w is 0, 1, 2 or 3,
with the proviso that when Z comprises a nitrile or azlactone functional group, then R¹ and R² are H.

The polymerizable ionic liquid may optionally comprise one or more additional components blended therewith.

As used herein, the term “on-demand debonding” means the ability to reduce the strength of an adhesive bond at will for the purpose of facilitating the separation (i.e. debonding) of adhesively joined components.

As used herein, a “pressure sensitive adhesive” or “PSA” is defined to possess the following properties: (1) aggressive and permanent tack; (2) adherence with no more than finger pressure; (3) sufficient ability to hold onto an adherend; and (4) sufficient cohesive strength to be removed cleanly from the adherend. Materials that have been found to function well as PSAs include polymers designed and formulated to exhibit the requisite viscoelastic properties resulting in a desired balance of tack, peel adhesion, and shear holding power. PSAs are characterized by being normally tacky at room temperature. PSAs are adhesives that satisfy the Dahlquist criteria for tackiness, which means that the shear storage modulus is typically 3×10⁵ Pa (300 kPa) or less when measured at 25° C. and 1 Hertz (6.28 radians/second). PSAs typically exhibit adhesion, cohesion, compliance, and elasticity at room temperature.

As used herein, the term “conductive” and “electrically conductive” are used interchangeably.

As used herein the terms “negative electrode” and “negative adhesive interface” are used interchangeably, and the terms “positive electrode” and “positive adhesive interface” are used interchangeably.

As used herein, the term “polymerizable” is applied to the compounds, also called “monomers”, that are polymerizable and/or crosslinkable as a result of initiation by thermal decomposition, redox reaction, or photolysis. Such compounds have at least one α, β-unsaturated site. In some embodiments, monomers having more than one α, β unsaturated site are termed “crosslinkers” but it will be understood that the term “monomer” includes, as appropriate in context, compounds having more than one such site.

As used herein, the term “substantial” or “substantially” means with relatively minor fluctuations or aberrations from the stated property, value, range of values, content, formula, and the like, and does not exclude the presence of additional materials, broader range values, and the like which do not materially affect the desired characteristics of a given composition, article, product, or method.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

In this application, terms such as “a,” “an,” and “the” are not intended to refer to only a singular entity, but include the general class of which a specific example may be used for illustration. The terms “a,” “an,” and “the” are used interchangeably with the phrases “at least one” and “one or more.” The phrases “at least one of” and “comprises at least one of” followed by a list refers to any one of the items in the list and any combination of two or more items in the list. As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and in certain embodiments, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

Reference throughout this specification to “some embodiments” means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful, and is not intended to exclude other embodiments from the scope of the disclosure.

The above summary of the present disclosure is not intended to describe each disclosed embodiment or every implementation of the present disclosure. The description that follows more particularly exemplifies illustrative embodiments.

### BRIEF DESCRIPTION OF THE DRAWINGS

FIG. 1A is a schematic side view of one exemplary article of the present application;

FIG. 1B is a schematic side view of a variation on the article in FIG. 1A;

FIG. 1C is a schematic side view of another variation on the article in FIG. 1A;

FIG. 2A is a schematic side view of another exemplary article of the present application;

FIG. 2B is a schematic side view of a variation on the article in FIG. 2A;

FIG. 3 is a plot of the tensile force in Newtons (y-axis) of Example E4 vs. the distance in millimeters (x-axis) between two 8-mm stainless steel plates being separated at a rate of 0.01 mm/second; and

FIG. 4 is a contour surface plot of work of adhesion per unit of surface area (denoted by shading on the scale) from tensile adhesion testing of Example E2, as a function of applied DC voltage (y-axis) and the duration (x-axis) over which the voltage was applied prior to separating the plates.

With reference to the figures, like reference numbers offset by multiples of 100 (e.g., 12 and 112 or 30 and 130) indicate like elements. Unless otherwise indicated, all figures and drawings in this document are not to scale and are chosen for the purpose of illustrating different embodiments of the invention. In particular, the dimensions of the various components are depicted in illustrative terms only, and no relationship between the dimensions of the various components should be inferred from the drawings, unless so indicated.

### DETAILED DESCRIPTION

In the following description of illustrative embodiments, reference is made to the accompanying figures of the drawing which form a part hereof, and in which are shown, by way of illustration, specific embodiments. It is to be understood that other embodiments may be utilized and structural changes may be made without departing from the scope of the present invention.

The articles of the present disclosure generally comprise a first component having a first electrically conductive surface, a second component having a second surface, and an adhesive composition disposed between the first electrically conductive surface and the second surface. The adhesive composition (described in more detail below) includes an adhesive comprising a cured polymerizable ionic liquid, and exhibits on-demand debonding behavior when subjected to a DC electric potential. The effort to separate the first component from the second component as measured, for example, by work of adhesion per surface area according to Test Method 2, is reduced by application of a DC electric potential across the adhesive composition.

The shape and form of the articles in the present disclosure are not particularly limiting. An article can be a finished product or a part for incorporation into, or attachment to, another object. The article is typically made up of at least two components that may be adhesively bonded together, and the article may be two-dimensional or three-dimensional in shape. Similarly, the shape and form of the components making up the article are also not particularly limiting. A component can be a single element or a combination of elements, and the component can be two-dimensional or three-dimensional. In some embodiments, two or more components are interconnected, or even two different sections of the same material (e.g., one end of a composite strip of material can be folded over so as to adhere to the opposite end of the strip).

In order to facilitate the separation of components joined together by the adhesive composition, a DC electric potential is applied across the adhesive composition prior to separation of the components. For example, the electric potential may be applied across two electrically conductive components on opposite sides of the adhesive composition, such that the surface of one component serves as a negative electrode (or negative adhesive interface) and the surface of the other component serves as the positive electrode (or positive adhesive interface). Alternatively, the electric potential may be applied across one electrically conductive component and an electrically conductive adhesive carrier of a two-sided tape, where the surface of the conductive component or the conductive adhesive carrier serves as the negative adhesive interface and the other of the surface of the conductive component or conductive adhesive carrier serves as the positive adhesive interface. Application of a DC current typically weakens the adhesive bond at the negative adhesive interface, thus reducing the amount of effort required to separate components in the article. The location of debonding can be reversed by simply changing the polarity of the electric potential.

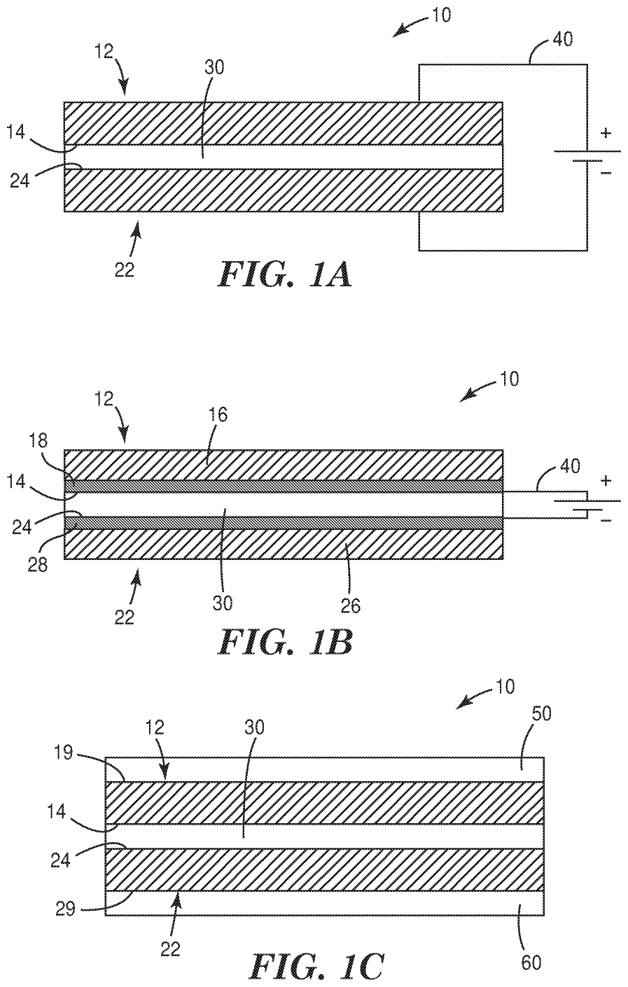

FIG. 1 illustrates one embodiment of an article of the present disclosure comprising two electrically conducting components joined together by the adhesive composition. With reference to FIG. 1A, article 10 comprises a first component 12 having a first electrically conductive surface 14 and a second component 22 having a second electrically conductive surface 24. The first and second components 12, 22 are each made from electrically conductive material(s). The nature of the conductive materials is not particularly limiting. In some embodiments, the first electrically conductive surface 14 and second electrically conductive surface 24 are cach selected from the group consisting of a metal, a mixed metal, an alloy, a metal oxide, a composite metal, a conductive plastic, a conductive polymer, or combinations thereof. In some embodiments, the composition of the first electrically conductive surface 14 is different from the composition of the second electrically conductive surface 24. In other embodiments, the compositions of the first and second electrically conductive surfaces 14, 24 are the same.

The adhesive composition 30 joins the first and second components 12, 22 together at the first conductive surface 14 and the second conductive surface 24. The adhesive composition exhibits on-demand debonding behavior by application of a DC electric potential across the adhesive composition 30. In this particular embodiment, the first conductive surface 14 serves as the positive adhesive interface and the second conductive surface 24 serves as the negative adhesive interface. Application of a DC electric potential 40 across the adhesive composition 30 results in a weakening of the adhesive bond at the negative adhesive interface (i.e. the second conductive surface 24), as measured, for example, according to the work of adhesion per surface arca, thus making it easier to separate the second component 22 from the first component 12. Preferably, little-to-no adhesive residue remains on the second conductive surface 24 after separation. In some embodiments, less then 10%, less then 5%, or less then 1% of the adhesive composition (by weight) remains on the second component 22 after separation. In some preferred embodiments, no adhesive composition remains on the second component 22 after separation. In some embodiments, it is possible to reuse the adhesive composition allowing the first component 12 to be rejoined to the second component 22 or adhered to a completely different component or article. If it is desirable that the adhesive remain on the second component 22 after separation, the polarity of the DC electric potential can be reversed so that the first conducting surface 14 serves as the negative adhesive interface.

Electrically conductive components include those components made entirely from electrically conducting material(s), as illustrated in FIG. 1A, as well as those components made from nonconducting material(s) coated with electrically conductive material(s), as illustrated in FIG. 1B. With reference to FIG. 1B, the first component 12 comprises a first nonconductive material 16 and a first electrically conductive coating 18 to provide the first electrically conductive surface 14. Similarly, the second component 22 comprises a second nonconductive material 26 and a second electrically conductive coating 28 to provide the second electrically conductive surface 24. Alternatively (not shown), one of the components could be made entirely of electrically conducting material(s) and the other component could be made of nonconducting material(s) coated with electrically conductive material(s). The conductive coating may only partially coat the component, as illustrated in FIG. 1B, or completely coat the outside surface of the component. For purposes of this disclosure, it is only necessary that the surface of the component in direct contact with the adhesive composition be sufficiently coated to weaken the adhesive bond at the negative adhesive interface when a DC electric potential is applied across the adhesive composition. In some embodiments, the coating is a solid layer. In other embodiments, the coating is pattern coated onto the surface of the component. As noted above, the electrically conductive material is not particularly limiting and can include materials selected from the group consisting of a metal, a mixed metal, an alloy, a metal oxide, a composite metal, a conductive plastic, a conductive polymer, or combinations thereof.

The adhesive composition 30 in FIG. 1B joins the first and second components 12, 22 together. The first conductive surface 14 serves as the positive adhesive interface and the second conductive surface 24 serves as the negative adhesive interface. Application of a DC electric potential 40 across the adhesive composition 30 results in a weakening of the adhesive bond at the negative adhesive interface (i.e. second electrically conductive surface 24), as measured, for example, according to the work of adhesion per surface area, thus making it easier to separate the second component 22 from the first component 12. If it is desirable that the adhesive composition remain predominately on the second component, the polarity of the DC electric potential can be reversed so that the first electrically conducting surface serves as the negative adhesive interface.

The articles in FIG. 1A-B can be further adapted to join and subsequently debond nonconductive objects or elements using the adhesive composition, as illustrated in FIG. 1C. The article in FIG. 1C includes a conductive first component 12 having a first electrically conductive surface 14, and a conductive second component 22 having a second electrically conductive surface 24. The first and second components 12, 22 are joined together by the adhesive composition 30. Although the first and second components can be made of electrically conductive material(s), it should also be understood that the first and/or second components can be made from nonconductive material(s) and coated with electrically conductive material(s), such as illustrated in FIG. 1B. FIG. 1C differs from FIGS. 1A-B in that a first outer adhesive 50 is added to a second side 19 of the first component 12 opposite the adhesive composition 30, and a second outer adhesive 60 is added to a first side 29 of the second component 22 opposite the adhesive composition 30. The outer adhesives 50, 60 can be the same or different and are not particularly limiting, as long as the outer adhesives 50, 60 bond to the nonconductive object or element and function for the intended application. In some embodiments, the outer adhesive is a pressure sensitive adhesive. In some further embodiments, the outer adhesive is an adhesive composition, as defined herein. An optional release liner (not shown) may be applied to the first outer adhesive 50, the second outer adhesive 60, or both to protect the outer adhesives during transport and storage of the article. In some embodiments, a release liner is applied to each of the first and second outer adhesives. In other embodiments, a release liner is applied to one of the outer adhesives and the article is wound up on itself so that the other outer adhesive is in direct contact with the release agent of the release liner for the purpose of storage and transport. The adhesive composition can then be unrolled when ready for use. Release liners can be made, for example, of kraft papers, polyethylene, polypropylene, polyester or composites of any of these materials. The liners are preferably coated with release agents such as fluorochemicals or silicones. In some preferred embodiments. the liners are papers, polyolefin films, or polyester films coated with silicone release materials. Examples of commercially available release liners include POLYSLIK™silicone release papers available from Loparex (Cary, NC), Silicone 1750 coated films from Infiana (Forchheim, Germany), siliconized polyethylene terephthalate films available from H.P. Smith Co. (Stoncham, MA), and 3M Scotchpak™ 9741 Release liner from 3M Company (St. Paul, MN).

In the embodiment illustrated in FIG. 1C, the first and second components are two-dimensional (e.g., sheet or multilayer film). However, it is not necessary, and one can conceive of applications where either one or both of the components is three-dimensional (e.g., special mounting features such as shaped indentation in which to seat the nonconductive object). In practice, one of the optional release liners is removed from the first outer adhesive 50 and the first outer adhesive adhered to a nonconductive object. Then, the second optional release liner is removed from the second outer adhesive 60 and the second outer adhesive 60 adhered to a different nonconductive object, such that the nonconductive objects are adhesively joined. The nonconductive objects can be separated on-demand by application of an electric potential across the adhesive composition, as illustrated in FIGS. 1A-B. In this instance, separation will result in one nonconductive object having the first component adhesively bonded thereto and the other nonconductive object with the second component adhesively bonded thereto.

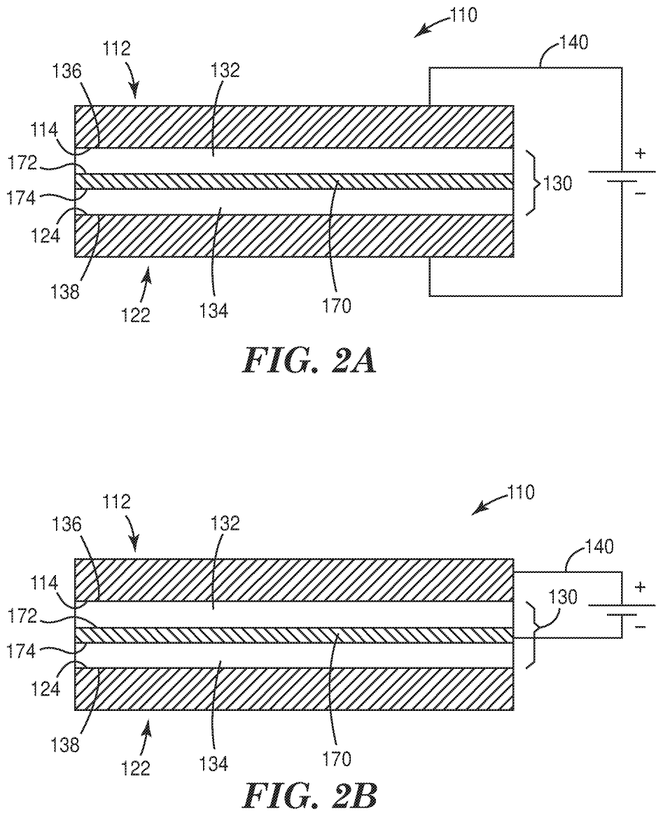

FIG. 2 illustrates another embodiment of an article 110 of the present application where the adhesive composition is a two-sided tape that joins the first and second components together.

With reference to FIG. 2A, the article 110 comprises a first component 112 having a first electrically conductive surface 114 and a second component 122 having a second electrically conductive surface 124. The first and second components can be made of conductive material(s), as illustrated in FIG. 2A, or one or both of the first and second components can be made of nonconductive material(s) and at least partially coated with electrically conductive material(s), as described above with respect to FIG. 1. The adhesive composition 130 is disposed between the first electrically conductive surface 114 and the second electrically conductive surface 124 and joins the first component 112 to the second component 122.

The adhesive composition 130 is a two-sided adhesive further comprising a carrier 170 having a first major surface 172 and a second major surface 174 opposite the first major surface. A first adhesive composition 132 comprising a cured first polymerizable ionic liquid is on the first major surface 172 of the carrier 170. Similarly, a second adhesive composition 134 comprising a cured second polymerizable ionic liquid is on the second major surface 174 of the carrier 170. In some embodiments, the composition of the first polymerizable ionic liquid is the same as the composition of the second polymerizable liquid. In other embodiments, the composition of the first polymerizable liquid is different from the composition of the second polymerizable liquid. A surface 136 of the first adhesive composition 132 opposite the carrier 170 is in contact with the first conductive surface 114 of the first component 112. A surface 138 of the second adhesive composition 134 opposite the carrier 170 is in contact with the second conductive surface 124 of the second component 122.

In some embodiments, the carrier is a porous material that allows for physical contact between the first and second adhesive compositions. Exemplary carriers include paper, woven or nonwoven fabrics, a porous film, a metal mesh, a metal grid, or combinations thereof. In some embodiments, the carrier is electrically conductive. Such conductive carriers may be porous or nonporous and include a metal mesh, a metal grid, a metal foil, a metal plate, a conductive polymer, a conductive foam, a conductive tissue, or combinations thereof.

In the embodiment illustrated in FIG. 2A, the first electrically conductive surface 114 serves as the positive adhesive interface and the second electrically conductive surface 124 serves as the negative adhesive interface. When the carrier is made from a porous material, application of a DC electric potential 140 across the adhesive composition 130 results in a weakening of the adhesive bond at the negative adhesive interface (i.e. second electrically conductive surface 124), as measured, for example, according to the work of adhesion per surface area, thus making it casier to separate the second component 122 from the first component 112. If it is desirable to separate the adhesive composition from the first component, the polarity of the DC electric potential can be reversed so that the first electrically conducting surface serves as the negative adhesive interface.

When the carrier in FIG. 2A is a nonporous conductive material, application of a DC electric potential 140 across the adhesive composition 130 can result in a weakening of the adhesive bond at the negative adhesive interface (i.e. second electrically conductive surface 124) and the first major surface 172 of the carrier 170.

In another embodiment, the carrier 170 is a conductive material that serves as either the positive or the negative adhesive interface during the debonding process. For example, with reference to FIG. 2B, the first conductive surface 114 of the first component 112 is the positive adhesive interface and the first major surface 172 of the carrier 170 is the negative adhesive interface. Application of a DC electric potential 140 across the first adhesive composition 132 will result in separation of the first and second components 112, 122 at the first major surface 172 of the carrier 170. Alternatively, the first component 112 can be removed from the first adhesive composition 132 by reversing the polarity of the DC electric potential.

In an additional embodiment, the conductive surface 124 of the second component 122 or the second major surface 174 of the carrier 170 can be the negative adhesive interface and the other of the conductive surface 124 of the second component 122 or the second major surface 174 of the carrier 170 can be the positive adhesive interface.

It should be understood, with reference to FIG. 2B, that when the carrier 170 serves as the negative or positive adhesive interface and the first conductive surface 114 of the first component 112 serves as the other of the negative or positive adhesive interface, only the first adhesive composition 132 across which the DC electric potential is applied need comprise a cured polymerizable ionic liquid. The second adhesive composition 134 can in fact be any type of adhesive. Similarly, when the carrier 170 serves as the negative or positive adhesive interface and the second conductive surface 124 of the second component 122 serves as the other of the negative or positive adhesive interface, only the second adhesive composition 134 across which the DC electric potential is applied need comprise a cured polymerizable ionic liquid. The first adhesive composition 132 can be any type of adhesive. Therefore, in such embodiments, a two-sided tape may be used to make the article which comprises a carrier having adhesive on both sides, where only one of the adhesives comprises a cured polymerizable ionic liquid. This construction would be similar to what is illustrated in FIG. 1C, where the second component 22 is a carrier.

As shown above, a two-sided tape with a conductive carrier allows the user to more strategically tailor the location of debonding within an article. This can be particularly advantageous when it is necessary to remove adhesive from a component prior to recycling and/or leave the adhesive on a component for repositioning or adherence to the same or different article. Further, by using a two-sided tape with a conductive carrier, at least one of the components need not be conductive in order to separate the first component from the second component. The carrier can serve as one of the electrodes, thus increasing the types of materials that can be included in the article (i.e. adhering two conductive components or adhering a conductive component to a nonconductive component).

The above embodiments illustrate exemplary configurations of the articles of the present disclosure and methods for debonding components within those articles. The adhesive composition will now be described in more detail.

### Adhesive Composition

The adhesive compositions of the present disclosure comprise a cured polymerizable ionic liquid. The polymerizable ionic liquid comprises:
a polymerizable anion and a cation corresponding to the conjugate acid of the imidazole compound of Formula I

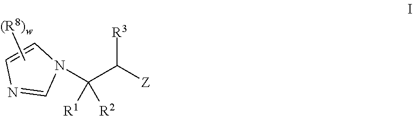

wherein
Z comprises a ketone, ester, amide, nitrile, or azlactone functional group,
R¹ is H or a C₁-C₂₅ alkyl group,
R² is H or —CO—X¹-R⁵, where R⁵ is a H or a C₁-C₂₅ alkyl group and X¹ is —O— or —NR⁶—, where R⁶ is H or a C₁-C₆ alkyl,
R³ is H or CH₃, preferably H, and
R⁸ is a (hetero)hydrocarbyl group which may be substituted at the 2-, 4- or 5-position, and w is 0, 1, 2 or 3,
with the proviso that when Z comprises a nitrile or azlactone functional group, then R¹ and R² are H.

In embodiments of Formula I where Z is an azlactone functional group, Z is of the formula:

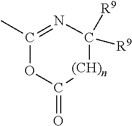

where each R⁹ is independently H, an alkyl group having 1 to 14 carbon atoms, and n is 0 or 1.

In other embodiments where Z comprises an ester, amide or ketone functional group Z is of the formula —C(O)—(X¹)ₐ—R¹⁰, where R¹⁰ is a (hetero)hydrocarbyl group, said (hetero)hydrocarbyl optionally substituted with one or more hydroxyl groups, and X¹ is —O— or —NR⁶—, where R⁶ is H or a C₁-C₆ alkyl, and a is 0 or 1. Preferably R¹⁰ is a hydrocarbyl group, and more preferably R¹⁰ is an alkyl group of 1 to 25 carbon atoms. R¹⁰ is optionally substituted with a hydroxyl group.

In some embodiments, R¹ is H, R² is H, R³ is H, w is 0, and Z is an ester. In the same or different embodiments, Z is —C(O)—O—R¹⁰ and R¹⁰ is a hydrocarbyl group, said hydrocarbyl optionally substituted with a hydroxyl group.

As used herein:
“acryloyl” is used in a generic sense and means not only derivatives of acrylic acid, but also amine, and alcohol derivatives, respectively;
“(meth)acryloyl” includes both acryloyl and methacryloyl groups; i.e. is inclusive of both esters and amides.

“poly(meth)acryloyl” means a compound having two or more (meth)acryloyl groups that may function as Michael acceptors.

“curable” means that a coatable material can be transformed into a solid, substantially non-flowing material by means of cooling (to solidity hot melts), heating (to dry and solidify materials in a solvent), chemical cross linking, radiation crosslinking, or the like.

“alkyl” includes straight-chained, branched, and cyclic alkyl groups and includes both unsubstituted and substituted alkyl groups. Unless otherwise indicated, the alkyl groups typically contain from 1 to 20 carbon atoms. Examples of “alkyl” as used herein include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, and norbornyl, and the like. Unless otherwise noted, alkyl groups may be mono- or polyvalent.

“heteroalkyl” includes both straight-chained, branched, and cyclic alkyl groups with one or more heteroatoms independently selected from S, O, and N with both unsubstituted and substituted alkyl groups. Unless otherwise indicated, the heteroalkyl groups typically contain from 1 to 20 carbon atoms. “Heteroalkyl” is a subset of “hydrocarbyl containing one or more S, N, O, P, or Si atoms” described below. Examples of “heteroalkyl” as used herein include, but are not limited to, methoxy, ethoxy, propoxy, 3,6-dioxaheptyl, 3-(trimethylsilyl)-propyl, 4-dimethylaminobutyl, and the like. Unless otherwise noted, heteroalkyl groups may be mono- or polyvalent.

“aryl” is an aromatic group containing 6-18 ring atoms and can contain optional fused rings, which may be saturated, unsaturated, or aromatic. Examples of an aryl groups include phenyl, naphthyl, biphenyl, phenanthryl, and anthracyl. Heteroaryl is aryl containing 1-3 heteroatoms such as nitrogen, oxygen, or sulfur and can contain fused rings. Some examples of heteroaryl groups are pyridyl, furanyl, pyrrolyl, thienyl, thiazolyl, oxazolyl, imidazolyl, indolyl, benzofuranyl, and benzthiazolyl. Unless otherwise noted, aryl and heteroaryl groups may be mono- or polyvalent.

“(hetero)hydrocarbyl” is inclusive of hydrocarbyl alkyl and aryl groups, and heterohydrocarbyl heteroalkyl and heteroaryl groups, the later comprising one or more catenary oxygen heteroatoms such as ether or amino groups. Heterohydrocarbyl may optionally contain one or more catenary (in-chain) functional groups including ester, amide, urea, urethane, and carbonate functional groups. Unless otherwise indicated, the non-polymeric (hetero)hydrocarbyl groups typically contain from 1 to 60 carbon atoms. Some examples of such heterohydrocarbyls as used herein include, but are not limited to, methoxy, ethoxy, propoxy, 4-diphenylaminobutyl, 2-(2′-phenoxyethoxy)ethyl, 3,6-dioxaheptyl, 3,6-dioxahexyl-6-phenyl, in addition to those described for “alkyl”, “heteroalkyl”, “aryl”, and “heteroaryl” supra.

The imidazole compounds of Formula I are Michael addition products of an imidazole compound and a Michael acceptor compound; i.e. a compound having an electron deficient double bond, and an electron-withdrawing functional group, including α, β-unsaturated esters, amides, ketones, nitriles and azlactones. Such compounds may be prepared as described in Scheme I.

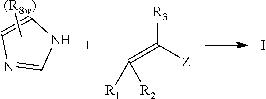

where
Z comprises a ketone, ester, amide, nitrile, or azlactone functional group,
R¹ is H or a C₁-C₂₅ alkyl group,
R² is H or —CO—X¹-R⁵, where R⁵ is a H or a C₁-C₂₅ alkyl group and X¹ is —O— or —NR⁶—, where R⁶ is H or a C₁-C₆ alkyl,
R³ is H or CH₃, preferably H, and
R⁸ is a (hetero)hydrocarbyl group which may be substituted at the 2-, 4- or 5-position, and w is 0, 1, 2 or 3.

Exemplary Michael acceptor compounds include the esters of either acrylic acid or methacrylic acid with non-tertiary alcohols such as ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, isooctylalcohol, 2-ethyl-1-hexanol, 1-decanol, 2-propylheptanol, 1-dodecanol, 1-tridecanol, 1-tetradecanol, citronellol, and dihydrocitronellol. Other exemplary Michael acceptor compounds include t-butyl acrylate, methyl methacrylate, isobutyl methacrylate, s-butyl methacrylate, t-butyl methacrylate, stearyl methacrylate, phenyl methacrylate, cyclohexyl methacrylate, isobornyl acrylate, isobornyl methacrylate, benzyl methacrylate, 3,3,5 trimethylcyclohexyl acrylate, cyclohexyl acrylate, N-octyl acrylamide, and propyl methacrylate. Yet other exemplary Michael acceptor compounds include 2-hydroxyethyl (meth)acrylate, acrylamide, mono- or di-N-alkyl substituted acrylamide, t-butyl acrylamide, dimethylaminoethyl acrylamide, N-octyl acrylamide, and poly(alkoxyalkyl) (meth)acrylates (e.g., 2-(2-ethoxyethoxy)ethyl (meth)acrylate, 2-ethoxyethyl (meth)acrylate, 2-methoxyethoxyethyl (meth)acrylate, 2-methoxyethyl methacrylate, polyethylene glycol mono(meth)acrylates).

In some embodiments, the imidazole compounds may be prepared by the Michael addition reaction of an imidazole compound to a poly(meth)acryloyl compound as illustrated in Scheme II:

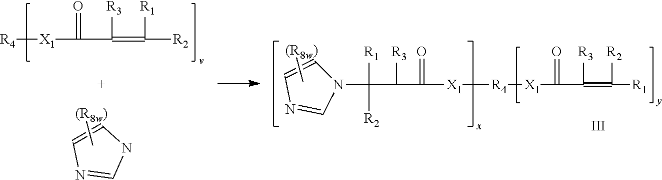

where
R¹ is H or a C₁-C₂₅ alkyl group,
R² is H or —CO—X¹-R⁵, where R⁵ is a H or a C₁-C₂₅ alkyl group and X¹ is —O— or —NR⁶—, where R⁶ is H or a C₁-C₆ alkyl,
R³ is H or CH₃,

R⁴ is a (hetero)hydrocarbyl linking groups that may further comprise one of more catenary (in-chain) functional groups, including ester, amide, urethane and other functional groups, and is preferably a hydrocarbyl group including alkylene, cycloalkylene, or combinations thereof, optionally substituted with one or more hydroxyl groups;
R⁸ is a (hetero)hydrocarbyl group, and w is 0, 1, 2 or 3;
X¹ is —O— or —NR⁶—, where R⁶ is H or a C₁-C₆ alkyl;
x is 1 to 6, preferably 1 to 4,
y is 0 to 2, and
v is x+y.

As illustrated supra, the compounds of Formula II may be prepared by Michael addition of an imidazole compound to a polyacryloyl compound. Useful polyacryloyl compounds include those of the general formula:

R⁴—(X¹—C(O)—CR³═CR¹R²)ᵥ III
wherein each X¹ is selected from alkylene, —O—, or —NR⁶—, where each R⁶ independently represents H or an alkyl group having from 1 to 6 carbon atoms;
R¹, R² and R³ are the same as those listed above for Scheme II;
R⁴ is a (hetero)hydrocarbyl linking groups that may further comprise one of more catenary (in-chain) functional groups, including ester, amide, urethane and other functional groups, and is preferably a hydrocarbyl group including alkylene, cycloalkylene, or combinations thereof, optionally substituted with one or more hydroxyl groups; and
v is greater than 1, preferably greater than or equal to 2 and is generally 2 to 6.

In one embodiment, R⁴ may be a polyvalent organic group having a valence of at least 2. Examples of polyvalent groups R⁴ include butylene: ethylene: propylene: and 4-oxaheptalene; hexylene; and 1,4-bis(methyl)cyclohexylene. All isomers or the alkylene groups are envisioned, such a 1,2-, 1,3- and 1,4- butylene isomers. The alkylene may be further substituted with a hydroxyl group. e.g. 2-hydroxy-1,3-propylene.

Useful polyacryl compounds include, for example, acrylate monomers selected from the group consisting of (a) diacryl containing compounds such as ethylene glycol diacrylate, 1,3-butylene glycol diacrylate, 1.4-butanediol diacrylate, 1,6-hexanediol diacrylate, cyclohexane dimethanol diacrylate, alkoxylated hexanediol diacrylate, neopentyl glycol diacrylate, caprolactone modified neopentylglycol hydroxypivalate diacrylate, cyclohexanedimethanol diacrylate, diethylene glycol diacrylate, dipropylene glycol diacrylate, bisphenol-A diacrylate, ethoxylated bisphenol-A diacrylate, hydroxypivalaldehyde modified trimethylolpropane diacrylate, neopentyl glycol diacrylate, polyethylene glycol diacrylate, propoxylated neopentyl glycol diacrylate, tetraethylene glycol diacrylate, tricyclodecanedimethanol diacrylate, triethylene glycol diacrylate, tripropylene glycol diacrylate; (b) triacryl containing compounds such as glycerol triacrylate, ethoxylated triacrylates (e.g., ethoxylated trimethylolpropane triacrylate, pentaerythritol triacrylate, propoxylated triacrylates (e.g., propoxylated glyceryl triacrylate, propoxylated trimethylolpropane triacrylate, tris(2-hydroxyethyl)isocyanurate triacrylate; (c) higher functionality acryl-containing compounds such as ditrimethylolpropane tetraacrylate, dipentaerythritol pentaacrylate, ethoxylated pentaerythritol tetraacrylate, pentaerythritol tetraacrylate, caprolactone modified dipentaerythritol hexaacrylate; (d) oligomeric acryl compounds such as, for example, urethane acrylates, polyester acrylates, epoxy acrylates; polyacrylamide analogues of the foregoing; and combinations thereof. Such compounds are available from vendors such as Sartomer Company, Exton, Pennsylvania; UCB Chemicals Corporation, Smyrna, Georgia; and Aldrich Chemical Company, Milwaukee, Wisconsin. Additional useful acrylate materials include hydantoin moiety-containing polyacrylates, for example, as described in U.S. Pat. No. 4,262,072 (Wendling et al.).

Other useful polyacryl compounds also include, for example, free-radically polymerizable acrylate oligomers and polymers having pendant (meth)acryl groups wherein at least two of the (meth)acryl groups are acryl groups. There is a differential reactivity between acryl and methacryl groups with respect to Michael-type addition. Michael-type addition typically occurs easily with acryl groups, but may occur only with difficulty if at all, in the case of methacryl groups. For this reason, the polyacryl component typically has at least two acryl group (e.g., as part of acryloxy or acrylamido functionality), although the poly (meth)acryl compound may also have additional (meth)acryl groups (e.g., as part of methacrylate or methacrylamido functionality). Advantageously, composition may be prepared in which Michael addition occurs through the acryl groups, leaving methacryl groups unreacted. Such unreacted methacryl groups may be subsequently free-radically polymerized.

With respect to the useful polyacryl compounds presented above, it will be understood that the corresponding amides or thioesters are also useful. The multifunctional ethylenically unsaturated monomer is preferably an ester of acrylic acid. It is more preferably selected from the group consisting of a difunctional ethylenically unsaturated ester of acrylic, a trifunctional ethylenically unsaturated ester of acrylic, a tetrafunctional ethylenically unsaturated ester of acrylic, and a combination thereof. Of these, difunctional and trifunctional ethylenically unsaturated esters of acrylic acid are more preferred.

Other useful acrylate oligomers include acrylated epoxies, for example, diacrylated esters of epoxy-functional materials (e.g., diacrylated esters of bisphenol A epoxy-functional material) and acrylated urethanes. Useful acrylated epoxies include, for example, acrylated epoxies available under the trade designations “EBECRYL 3500”, “EBECRYL 3600”, “EBECRYL 3700”, and “EBECRYL 3720” from UCB Chemicals Corporation. Useful acrylated urethanes include, for example, acrylated urethanes available under the trade designations “EBECRYL 270”, “EBECRYL 1290”, “EBECRYL 8301”, and “EBECRYL 8804” from UCB Chemicals Corporation.

The multifunctional ethylenically unsaturated monomer is preferably an ester of acrylic acid. It is more preferably selected from the group consisting of a difunctional ethylenically unsaturated ester of acrylic, a trifunctional ethylenically unsaturated ester of acrylic, a tetrafunctional ethylenically unsaturated ester of acrylic, and a combination thereof. Of these, difunctional and trifunctional ethylenically unsaturated esters of acrylic acid are more preferred.

Preferred multifunctional ethylenically unsaturated esters of acrylic acid and can be described by the formula:

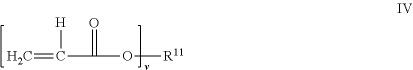

R¹¹ is an alkylene, cycloalkylene, or combinations thereof, optionally substituted with a hydroxyl group, generally R¹⁰ is the residue of a polyol; and
v is greater than 1, preferably greater than or equal to 2 and is generally 2 to 6.

Examples of suitable multifunctional ethylenically unsaturated esters of acrylic acid are the polyacrylic acid or polymethacrylic acid esters of polyhydric alcohols including, for example, the diacrylic acid and dimethylacrylic acid ester of aliphatic diols such as ethyleneglycol, triethyleneglycol, 2,2-dimethyl-1,3-propanediol, 1,3-cyclopentanediol, 1 -ethoxy-2,3-propanediol, 2-methyl-2,4-pentanediol, 1,4-cyclohexanediol, 1,6-hexamethylenediol, 1,2-cyclohexanediol, 1,6-cyclohexanedimethanol; the triacrylic acid esters of aliphatic triols such as glycerin, 1,2,3-propanetrimethanol, 1,2,4-butanetriol, 1,2,5pentanetriol, 1,3,6-hexanetriol, and 1,5,10-decanetriol; the triacrylic acid esters of tris(hydroxyethyl) isocyanurate; the tetraacrylic acid esters of aliphatic triols, such as 1,2,3,4-butanetetrol, 1,1,2,2-tetramethylolethane, 1,1,3,3-tetramethylolpropane, and pentaerythritol tetraacrylate; the pentaacrylic acid and pentamethacrylic acid esters of aliphatic pentols such as adonitol; the hexaacrylic acid esters of hexanols such as sorbitol and dipentaerythritol; the di acrylic acid esters of aromatic diols such as resorcinol, pyrocatechol, bisphenol A, and bis(2-hydroxyethyl) phthalate; the triacrylic acid ester of aromatic triols such as pyrogallol, phloroglucinol, and 2-phenyl-2,2-methylolethanol; and the hexaacrylic acid esters of dihydroxy ethyl hydantoin; and mixtures thereof.

The compounds of Formulas II function as reactive monomers and thus are substantially unpolymerized in the curable composition at the time the curable composition is applied to a substrate. Hence, the curable composition hardens upon curing via polymerization of the ethylenically unsaturated groups of the (e.g. multifunctional) polymerizable ionic liquid. In some favored embodiments, the compounds of Formulas II and IV are sufficiently low in viscosity that they act as a reactive diluent. In such embodiment, the composition can advantageously be substantially free of solvents, especially organic solvents. This can result in increased efficiency with respect to manufacturing time as well as energy consumption by reducing or eliminating drying the composition prior to curing. This can also reduce the volatile organic content (VOC) emissions of the composition.

Compounds of Formula I, where Z is an azlactone functional group may be prepared by Michael addition of an imidazole compound to an azlactone compound as shown in Scheme III:

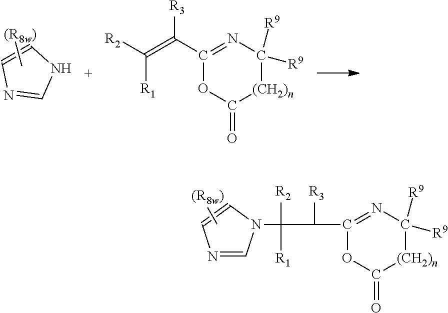

where
R¹ and R² are H:
R³ is H or CH₃;
R⁸ is a (hetero)hydrocarbyl group, including alkyl and aryl, preferably an alkyl group, and w is 0, 1, 2 or 3: and
each R⁹ is independently H, an alkyl group having 1 to 14 carbon atoms, and n is 0 or 1.

The anionic monomers of the polymerizable ionic liquid have an ethylenically unsaturated polymerizable groups and an acid group. The acid functional group may be an acid per se, such as a carboxylic acid, or a portion may be the conjugate base thereof. In the presence of the imidazole compound, these acid functional monomers form the conjugate base.

Useful acid functional monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, β-carboxyethyl (meth)acrylate, 2-sulfoethyl methacrylate, styrene sulfonic acid, 2-acrylamido-2-methylpropanesulfonic acid, vinylphosphonic acid, and mixtures thereof.

Due to their availability, acid functional monomers are generally selected from ethylenically unsaturated carboxylic acids, i.e. (meth)acrylic acids. When even stronger acids are desired, acidic monomers include the ethylenically unsaturated sulfonic acids and ethylenically unsaturated phosphonic acids. Depending on the desired end use and physical properties of the final composition, the acid functional monomer may be used in amounts of 5 molar equivalents or more relative to the molar equivalents of the imidazole groups. In some embodiments the molar ratio of acid groups to imidazole groups is approximately equimolar ±20%.

Preferred polymerizable ionic liquids exhibit a high air to nitrogen curing exotherm ratio. The air to nitrogen curing ratio is typically at least 0.70. In preferred embodiments, the air to nitrogen curing exotherm ratio is typically at least the 0.80 and preferably at least 0.90. For embodiments wherein the air to nitrogen curing ratio of the polymerizable ionic liquid is sufficiently high, the polymerizable ionic liquid can advantageously be substantially completely cured in air (i.e. an oxygen rich environment) rather than requiring curing in the absence of oxygen.

The polymerizable ionic liquid may also comprise other conventional (e.g. (meth)acrylate) ethylenically unsaturated monomer(s), oligomer(s), or polymer(s). By “optional monomers” is it meant an ethylenically unsaturated monomer that is not a polymerizable ionic liquid, and includes polar and nonpolar monomers and oligomers, as described more fully herein. Although conventional monomers are polymerizable and many are liquids at 25° C., conventional monomers are typically non-ionic, lacking a cation and an anion.

Conventional (meth)acrylate monomers typically have an air to nitrogen curing exotherm ratio of no greater than 0.50, 0.40, 0.35, 0.20, or 0.25 or lower. For example, triethylene glycol dimethacrylate (TEGMA) has been found to have an air to nitrogen curing exotherm ratio of about 0.36; whereas hydroxyethyl methacrylate (HEMA) has been found to have an air to nitrogen curing exotherm ratio of less than 0.25. Although the photocuring of conventional (meth)acrylate monomers and especially methacrylate monomers is typically inhibited by oxygen present in air, the inclusion of the (e.g. multifunctional) polymerizable ionic liquid can sufficiently increase the air to nitrogen curing exotherm of the mixture such that the mixture can advantageously be substantially completely cured in air. For embodiments wherein the composition is to be cured in air and the multifunctional polymerizable ionic liquid is combined with the “optional” polymerizable (meth)acrylate monomer, which exhibits a lower air to nitrogen curing exotherm ratio, the air to oxygen curing exotherm ratio of the (e.g. multifunctional) polymerizable ionic liquid, described herein, is at least 0.85, preferably at least 0.90, and more preferably at least 0.95.

The polymerizable ionic liquid composition may further comprise (meth)acrylate ester monomers as an “optional” monomer. The (meth)acry late ester monomer useful in preparing the acid functional (meth)acrylate adhesive copolymer is a monomeric (meth)acrylic ester of a non-tertiary alcohol, which alcohol contains from 1 to 14 carbon atoms and preferably an average of from 4 to 12 carbon atoms.

Examples of monomers suitable for use as the (meth)acrylate ester monomer include the esters of either acrylic acid or methacrylic acid with non-tertiary alcohols such as ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, isooctylalcohol, 2-ethyl-1-hexanol, 1-decanol, 2-propylheptanol, 1-dodecanol, 1-tridecanol, 1-tetradecanol, citronellol, dihydrocitronellol, and the like. In some embodiments, the preferred (meth)acrylate ester monomer is the ester of (meth)acrylic acid with butyl alcohol or isooctyl alcohol, or a combination thereof, although combinations of two or more different (meth)acrylate ester monomer are suitable. In some embodiments, the preferred (meth)acrylate ester monomer is the ester of (meth)acrylic acid with an alcohol derived from a renewable source, such as 2-octanol, citronellol, dihydrocitronellol. Other suitable monomers include branched long chain acrylates, such as those described in U.S. Pat. No. 8,137,807 (Clapper, et al.). Additional suitable alkyl monomers include secondary alkyl acrylates, such as those described in U.S. Pat. No. 9,102,774 (Clapper, et al.).

In some embodiments it is desirable for the (meth)acrylic acid ester monomer to include a high T_{g} monomer, have a T_{g} of at least 25° C., and preferably at least 50° C. Suitable high Tg monomers include Examples of suitable monomers useful in the present invention include, but are not limited to, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl methacrylate, isobornyl acrylate, isobornyl methacrylate, benzyl methacrylate, 3,3,5 trimethylcyclohexyl acrylate, cyclohexyl acrylate, N-octyl acrylamide, and propyl methacrylate or combinations.

The (meth)acrylate ester monomer is present in an amount of 60 to 99.5 parts by weight based on 100 parts total “optional” monomer content used to prepare the polymer. Preferably (meth)acrylate ester monomer is present in an amount of 80 to 95 parts by weight based on 100 parts total monomer content. When high Tg monomers are included, the copolymer may include up to 40 parts by weight, preferably up to 20 parts by weight of the 60 to 99.5 parts by weight of (meth)acrylate ester monomer component.

The polymerizable ionic liquid may further comprise polar monomers as an optional “other monomer”. The polar monomers useful in preparing the copolymer are both somewhat oil soluble and water soluble, resulting in a distribution of the polar monomer between the aqueous and oil phases in an emulsion polymerization. As used herein the term “polar monomers” are exclusive of acid functional monomers.

Representative examples of suitable polar monomers include but are not limited to 2-hydroxyethyl (meth)acrylate; N-vinylpyrrolidone; N-vinylcaprolactam; acrylamide; mono- or di-N-alkyl substituted acrylamide; t-butyl acrylamide; dimethylaminoethyl acrylamide; N-octyl acrylamide; poly(alkoxyalkyl) (meth)acrylates including 2-(2-ethoxyethoxy)ethyl (meth)acrylate, 2-ethoxyethyl (meth)acrylate, 2-methoxyethoxyethyl (meth)acrylate, 2-methoxyethyl methacrylate, polyethylene glycol mono(meth)acrylates; alkyl vinyl ethers, including vinyl methyl ether; and mixtures thereof. Preferred polar monomers include those selected from the group consisting of 2-hydroxyethyl (meth)acrylate and N-vinylpyrrolidinone. The polar monomer may be present in amounts of 0 to 30 parts by weight, preferably 0.5 to 15 parts by weight, based on 100 parts by weight “optional” monomer.

The polymerizable ionic liquid may further comprise vinyl monomers as the optional “optional” monomer, and includes vinyl esters (e.g., vinyl acetate and vinyl propionate), styrene, substituted styrene (e.g., α-methyl styrene), vinyl halide, and mixtures thereof. As used herein vinyl monomers are exclusive of acid functional monomers, acrylate ester monomers and polar monomers. Such vinyl monomers are generally used at 0 to 5 parts by weight, preferably 1 to 5 parts by weight, based on 100 parts by weight “optional” monomer.

The polymerizable ionic liquid may further comprise a multifunctional poly (meth)acryloyl monomer incorporated into the blend of polymerizable monomers as a component of the “optional” monomers. Multifunctional acrylates are particularly useful for emulsion or UV polymerization. Examples of useful multifunctional (meth)acrylate include, but are not limited to, di(meth)acrylates, tri(meth)acrylates, and tetra(meth)acrylates, such as 1,6-hexanediol di(meth)acrylate, poly(ethylene glycol) di(meth)acrylates, polybutadiene di(meth)acrylate, polyurethane di(meth)acrylates, and propoxylated glycerin tri(meth)acrylate, and mixtures thereof.

The amount and identity of multifunctional (meth)acrylate is tailored depending upon the particular application.

Typically, the multifunctional (meth)acrylate is present in amounts less than 5 parts based on total dry weight of adhesive composition. More specifically, the crosslinker may be present in amounts from 0.05 to 20 parts, preferably 0.05 to 1 parts, based on 100 parts “optional” monomers of the adhesive composition.

In some embodiments, the “optional” monomer may comprise:
i. 60 to 99.5 wt % of an (meth)acrylic acid ester monomer;
ii. 0 to 30 wt % of a non-acidic functional, ethylenically unsaturated polar monomer; and
iii. 0 to 20 wt % of a multifunctional (meth)acrylate; based upon the total weight of the optional monomer component.

In further embodiments, the “optional” monomer component may comprise:
i. 60 to 99.5 parts by weight of an (meth)acrylic acid ester monomers;
ii. 0.5 to 15 parts by weight of an acid functional ethylenically unsaturated monomer;
iii. 0 to 30 parts by weight of a non-acid functional, ethylenically unsaturated polar monomer;
iv. 0 to 5 parts vinyl monomer; and
V. 0 to 20 parts of a multifunctional (meth)acrylate; based upon the total weight of the optional monomer component.

Some portions of the (meth)acrylic acid ester monomer units may be hydrolyzed after the copolymer is prepared.

Optionally, compositions may contain solvents (e.g., alcohols (e.g., propanol, ethanol), ketones (e.g., acetone, methyl ethyl ketone), esters (e.g., ethyl acetate), other nonaqueous solvents (e.g., dimethylformamide, dimethylacetamide, dimethylsulfoxide, 1-methyl-2-pyrrolidinone)), and water.

If desired, the compositions can contain additives such as indicators, dyes, pigments, fillers, inhibitors, accelerators, viscosity modifiers, wetting agents, buffering agents, radical and cationic stabilizers (for example BHT), and other similar ingredients that will be apparent to those skilled in the art.

The polymerizable ionic liquid, including the “optional” monomers, may be polymerized by any conventional free radical polymerization method, including solution, radiation, bulk, dispersion, emulsion, and suspension processes. The resulting (co)polymers may be random or block (co)polymers.

Initiators useful in preparing the (meth)acrylate adhesive copolymers used in the present invention are initiators that, on exposure to heat, generate free-radicals which initiate (co)polymerization of the monomer mixture. Water-soluble initiators are preferred for preparing the (meth)acrylate polymers by emulsion polymerization. Suitable water-soluble initiators include but are not limited to those selected from the group consisting of potassium persulfate, ammonium persulfate, sodium persulfate, and mixtures thereof; oxidation-reduction initiators such as the reaction product of the above-mentioned persulfates and reducing agents such as those selected from the group consisting of sodium metabisulfite and sodium bisulfite; and 4,4-azobis(4-cyanopentanoic acid) and its soluble salts (e.g., sodium, potassium). The preferred water-soluble initiator is potassium persulfate. Suitable oil-soluble initiators include but are not limited to those selected from the group consisting of azo compounds such as VAZO™ 64 (2,2″-azobis(isobutyronitrile)) and VAZO™ 52 (2,2″-azobis(2,4-dimethylpentanenitrile)), both available from E.I. du Pont de Nemours Co., peroxides such as benzoyl peroxide and lauroyl peroxide, and mixtures thereof. The preferred oil-soluble thermal initiator is (2,2′-azobis(isobutyronitrile)). When used, initiators may comprise from about 0.05 to about 1 part by weight, preferably about 0.1 to about 0.5 part by weight based on 100 parts by weight of monomer components in the pressure-sensitive adhesive.

Alternatively, the mixture can be polymerized by techniques including, but not limited to, the conventional techniques of solvent polymerization, dispersion polymerization, and solventless bulk polymerization. The monomer mixture may comprise a polymerization initiator, especially a thermal initiator or a photoinitiator of a type and in an amount effective to polymerize the comonomers, as previously described. A typical solution polymerization method is carried out by adding the monomers, a suitable solvent, and an optional chain transfer agent to a reaction vessel, adding a free radical initiator, purging with nitrogen, and maintaining the reaction vessel at an elevated temperature, typically in the range of about 40 to 100° C. until the reaction is completed, typically in about 1 to 20 hours, depending upon the batch size and temperature. Examples of the solvent are methanol, tetrahydrofuran, ethanol, isopropanol, acetone, methyl ethyl ketone, methyl acetate, ethyl acetate, toluene, xylene, and an ethylene glycol alkyl ether. Those solvents can be used alone or as mixtures thereof.

In a typical photopolymerization method, a monomer mixture may be irradiated with ultraviolet (UV) rays in the presence of a photopolymerization initiator (i.e., photoinitiators). Preferred photoinitiators are those available under the trade designations IRGACURE™ and DAROCUR™ from Ciba Specialty Chemical Corp., Tarrytown, NY and include 1-hydroxy cyclohexyl phenyl ketone (IRGACURE™ 184), 2,2-dimethoxy-1,2-diphenylethan-1-one (IRGACURE 651), bis(2,4,6-trimethylbenzoyl)phenylphosphineoxide (IRGACURE™ 819), 1-1-[4-(2-hydroxyethoxy)phenyl]-2-hydroxy-2-methyl-1-propane-1-one (IRGACURE™ 2959), 2-benzyl-2-dimethylamino-1-(4-morpholinophenyl)butanone (IRGACURE™ 369), 2-methyl-1-[4-(methylthio)phenyl]-2-morpholinopropan-1-one (IRGACURE™ 907), and 2-hydroxy-2-methyl-1-phenyl propan-1-one (DAROCUR™ 1173). Particularly preferred photoinitiators are IRGACURE™ 819, 651, 184 and 2959.

Solventless polymerization methods, such as the continuous free radical polymerization method described in U.S. Pat. Nos. 4,619,979 and 4,843, 134(Kotnour et al.), the essentially adiabatic polymerization methods using a batch reactor described in U.S. Pat. No. 5,637,646 (Ellis), and, the methods described for polymerizing packaged pre-adhesive compositions described in U.S. Pat. No. 5,804,610 (Hamer et al.) may also be utilized to prepare the polymers.

### Coating Processes

The polymerizable ionic liquids can be applied to the surface of a component (e.g., carrier, substrate, surface of article, etc.) using a variety of conventional coating methods. In some embodiments, the polymerizable ionic liquid, including any “optional” monomers, is a pre-adhesive composition comprising the conjugate acid of the imidazole compounds of Formulas I or II and a polymerizable anionic monomer. Suitable coating methods include, for example, spin coating, knife coating, die coating, wire coating, flood coating, padding, spraying, roll coating, dipping, brushing, foam application, and the like. The coating is optionally dried and at least partially, typically completely, cured using an energy source. In some embodiments, the pre-adhesive mixture comprises a photoinitiator and the mixture is cured or partially cured by UV irradiation to form the adhesive composition.

In some embodiments the adhesive composition is substantially free of uncured polymerizable ionic liquid, i.e. <10% extractable. The extent of curing can be determined by various methods known in art. One common method is to determine the amount of uncured material by solvent extraction. In some embodiments, the amount of uncured extractable polymerizable ionic liquid is less than 10%, more preferably less than 5%, and most preferably less than 1% by weight of the cured composition.

In some embodiments, the thickness of the adhesive composition after curing is at least 10 μm, at least 100 μm, at least 500 μm, or at least 1000 μm. In some embodiments, the thickness of the adhesive composition is up to 2 mm, up to 1000 μm, up to 500 μm, or up to 100 μm. In some embodiments, the thickness of the adhesive composition ranges from 10 μm to 2 mm.

In some embodiments, the adhesive composition comprises a cured polymerizable ionic liquid. In other embodiments, the adhesive composition is a single-side tape comprising a carrier and the cured polymerizable ionic liquid applied to one side of the carrier. In yet other embodiments, the adhesive composition is a double-sided tape comprising a carrier and a cured first polymerizable ionic liquid applied to one side of the carrier and a cured second polymerizable ionic liquid applied to the opposite side of the carrier. The first and second polymerizable ionic liquids can be the same or different. Suitable carrier materials are described above.

### Applications

The articles of the present disclosure can provide a number of advantages. Components within the article may be separated (i.e. debonded) on-demand. As noted above, on-demand debonding within an article occurs by application of a DC electric potential across the adhesive composition to cause a weakening of the adhesive bond at the negative adhesive interface (i.e. negative electrode), thus decreasing the effort required to separate the components within an article. The weakening of the adhesive bond increases with an increase in DC electric potential (Voltage), an increase in duration of the applied DC electric potential, or a combination thereof. Thus, users can tailor the conditions for on-demand debonding to the application or need. For example, users can increase the duration of the applied DC electric potential when the application calls for lower voltages. In some embodiments, the on-demand debonding occurs with an applied DC electric potential of up to 1600 V/mm, of up to 800 V/mm, of up to 250 V/mm, or up to 90 V/mm. In some embodiments, the on-demand debonding occurs within less than 20 seconds, less than 15 seconds, less than 10 seconds, less than 5 seconds, less than 3 seconds or less than 1.5 seconds after application of the applied DC electric potential.

The articles of the present disclosure also benefit from the nature and degree of ionic content in the adhesive composition. For example, polymerized ionic content typically provides better adhesion than a composition containing the same ionic content in unpolymerized (i.e. free) form, thus insuring the components do not prematurely disengage during use. In some embodiments, the adhesive compositions of the present disclosure exhibit a 180° peel from glass at 12 inches/minute (30.48 cm/min) of at least 0.5 N/cm, 1.0 N/cm, 1.5 N/cm, 2.0 N/cm, 2.5 N/cm, 3.0 N/cm, 3.5 n/cm or 4.0 N/cm, as measured according to Test Method 1.

Additionally, it is possible to achieve higher levels of ionic content in the adhesive compositions through polymerization of the ionic liquids. In some embodiments, the adhesive composition comprises a polymerized ionic content of at least 5%, 10%, 15%, 20%, 25%, 30%, 35%, 40%, 45%, 50%, 55%, 60%, 65%, 70%, 75%, 80%, 85% or 90%. Higher ionic content was found to generally improved adhesive debondment upon application of a DC applied potential. The weakening of the adhesive bond during debondment can be measured, for example, by the % change in work of adhesion per surface area for two components bonded together with the adhesive composition. In some embodiments, the % change in work of adhesion per surface area at 0 V and −25 V for 100 seconds is at least 10%, at least 15%, at least 20%, at least 30%, at least 40%, at least 60%, at least 70%, at least 80%, at least 90%, or at least 95%. In some embodiments, the % change in the work of adhesion per surface area for a component adhesively bonded to an article with the adhesive composition at 0 V and −25 V for 100 seconds ranges from 10% to 100%, from 10% to 99%, from 40% to 99%, from 60% to 99%, from 70% to 99%, or from 80% to 99%. In some embodiments, the DC applied potential is sufficient to completely disengage a component from the article without user intervention.

Thus, components may be securely adhered to each other using the adhesive composition and conveniently separated upon application of a DC applied potential. In some embodiments, the adhesive compositions of the present disclosure exhibit a 180° peel from glass at 12 inches/minute (30.48 cm/min) of at least 0.5 N/cm and a % change in work of adhesion per surface area at 0 V and −25 V for 100 seconds of at least 10%.

Another related advantage of the article of the present application is the ability to dictate the location of debondment by the direction of the applied potential across the adhesive composition. Adhesive compositions of the present application typically debond from the negative adhesive interface. Preferably, little-to-no adhesive residue remains on the negative adhesive interface after separation. In some embodiments, less than 10%, less than 5%, or less than 1% of the adhesive composition (by weight) remains on the negative adhesive interface after debonding. In some preferred embodiments, no adhesive composition remains on the negative adhesive interface after debonding. This allows the user to cleanly separate the components at the interface of choice. In some constructions, it may be possible to debond the adhesive composition at one interface during the life of the article and debond the adhesive composition at another interface at the end life of the article, as recycling and environmental regulations may dictate.

The articles of the present application can provide for a variety of on-demand debonding solutions. In robotics, the article may include a mechanical arm coated at one end with the adhesive composition for use in gripping objects (e.g., components) used to perform a variety of tasks. For example, the object may be a screw driver or soldering device. Once the task has been completed, the object can be disengaged by application of an electric potential across the adhesive composition. In some embodiments, the separation could be designed such that the adhesive composition remains on the mechanical arm for gripping a new and different object.

The articles of the present application could be used, for example, in animal tracking collars where researchers must typically sedate an animal both during the application and removal of the collar. Using the articles of the present application, it is possible to create a collar that is designed to fall off at the end of its life cycle. For example, the collar could be secured around the neck of the animal using the adhesive composition. A small battery, which is used to collect the tracking information, could also be used near the end of the collection cycle to apply a potential across the adhesive composition that would then debond the adhesive and allow the collar to fall to the ground. The collar could then be picked up by researchers using a tracking device.

In another application, the article could be used in the packing and shipping industry. The adhesive composition could be used to bundle packages together. Upon arrival at their destination, a carrier employee could apply a current to separate the packages for delivery.

The article may also be a piece of equipment or consumer product comprising one or more components that require periodic service or replacement. For example, a service panel could be adhesively joined to a housing by the adhesive composition and the panel removed by application of a DC applied potential across the adhesive composition. The panel could then be replaced after service and, in some embodiments, repositioned using the same adhesive composition originally applied during manufacture.

The article may also be a multicomponent product that has reached the end of its product lifecycle and at least some, if not all, of the components are recyclable. If the components are joined by the adhesive composition, it is possible to cleanly separate out the recyclable components by application of a DC electric potential across the adhesive composition.

The above applications are not meant to be limiting. The articles and methods of the present application can find use in any variety of applications benefiting from on-demand adhesive debonding.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims

Unless otherwise noted, all parts, percentages, ratios, etc. in the Examples and the rest of the specification are by weight.

TABLE 1
Materials Used in the Examples.

| Material | Abbreviation | Source |
|---|---|---|
| n-hexyl acrylate | nHA | Bimax, Glen Rock, Pennsylvania |
| 2-hydroxyethyl acrylate | HEA | BASF, Florham Park, New Jersey |
| Isobornyl Acrylate | IBOA | TCI, Tokyo, Japan |
| 2-hydroxy-2-methylpropiophenone | D1173 | TCI, Tokyo, Japan |
| 2,2-Dimethoxy-2- | I-651 | BASF, Florham Park, New Jersey under |
| phenylacetophenone | | the trade designation Irgacure 651 |
| n-Butyl Imidazole Adduct | nBA-I | Generated following Preparatory |
| | | Example 3A in U.S. Pat. No. 8,383,721 |
| 2-ethylhexyl Imidazole Adduct | 2EHA-I | Generated following Preparatory |
| | | Example 1 in U.S. Pat. No. 8,383,721 |
| Isobornyl imidazole Adduct | IBOA-I | Generated following Preparatory |
| | | Example 5 in U.S. Pat. No. 8,383,721 |
| 1,6-Hexanediol Diacrylate | HDDA | Alfa Aesar, Ward Hill, Massachusetts |
| 1,6-Hexanediol Diimidazole | HDDA-I | Generated following Preparatory |
| Adduct | | Example 13 in U.S. Pat. No. 8,383,721 |
| Acrylic Acid | AA | Alfa Aesar, Ward Hill, Massachusetts |
| Propionic Acid | PA | Avantor Performance Materials Center |
| | | Valley, Pennsylvania |
| Tissue Scrim, cellulosic/paper, | Tissue | MBL Beijing Biotech Co., Ltd, Beijing, |
| basis weight 14.5 grams per | | China |
| square meter (g/m²), caliper | | |
| approximately 30 micrometers | | |
| (μm) | | |
| Nylon Scrim, basis weight 10.2 | Nylon | Cerex Advanced Fabrics, Inc., |
| g/m², caliper approximately 100 | | Cantonment, Florida |
| μm | | |

### Preparation of Prepolymer Solution

275 grams (g) of nHA, 150 g of IBOA, 75 g of HEA, and 0.15 g of D1173 were mixed together in a clear glass jar. The glass jar was then purged with nitrogen for 5 minutes to remove dissolved oxygen and then placed in front of an ultraviolet (UV) light with wavelength of 365 nanometers (nm) at an intensity of 0.3 milliwatts per square centimeter (mW/cm²) until a coatable viscosity was achieved. A typical target for the coatable viscosity for this step is approximately 3000 centipoise (cP) at room temperature.

### Comparative Examples C1-C6 and Examples E1-E8. Preparation of Pre-Adhesive Formulations

Pre-adhesive formulations were prepared by combining the prepolymer solution with the ingredients summarized in Table 2. The ingredients were combined in the amounts listed and mixed for 24 hours. The polymerizable ionic content was calculated on a wt % basis by summing all the ingredients considered both ionic and polymerizable. The total ionic content was calculated on a wt % basis by summing all the components considered ionic. The results are summarized in Table 2.

### Preparation of Single Layer Transfer Adhesives

The pre-adhesive formulations for Comparative Examples C1-C6 and Examples E1-E6 were each coated at a wet coat weight of 0.15 millimeters (mm) between silicone treated PET release liners (RF02N/RF32N available from SKC Haas, Seoul, South Korea). This construction was then cured using approximately 950 millijoules per square centimeter (mJ/cm²) of 360 nm wavelength UV irradiation.

### Preparation of Double-Coated Adhesives With Carrier Layer

The preparation of double-coated adhesive on either a nylon or a tissue carrier layer was conducted in a similar manner to the preparation of the single layer transfer adhesives provided above with the following exceptions. The pre-adhesive formulation for Example E5 was coated between two silicone treated PET liners at a thickness of 0.05 mm and cured using approximately 950 mJ/cm² of 360 nm wavelength UV irradiation. The top liner was removed and a 0.05 mm layer of tissue or nylon material was laminated to the exposed surface of the adhesive. A second layer of the same pre-adhesive formulation was coated at a thickness of 0.05 mm on top of the nylon or tissue side of the construction and then cured using approximately 950 mJ/cm² of 360 nm wavelength UV irradiation.

TABLE 2
Composition of Examples (parts by weight).

| | | | | | | | | | | | Polymerizable | Total |
|---|---|---|---|---|---|---|---|---|---|---|---|---|
| | | | | | | | | | | | Ionic | Ionic |
| | | nBA-I | 2EHA-I | IBOA-I | Pre-polymer | AA | PA | HDDA-I | I-651 | HDDA | Content | Content |
| Exs. | Carrier | wt % | wt % | wt % | wt % | wt % | wt % | wt % | wt % | wt % | Wt % | Wt % |
| C1 | none | 1.9% | 1.9% | 0.0% | 94.5% | 0.0% | 1.3% | 0.0% | 0.4% | 0.1% | 0 | 5.0% |
| C2 | none | 3.9% | 3.9% | 0.0% | 89.1% | 0.0% | 2.6% | 0.0% | 0.4% | 0.1% | 0 | 10.2% |
| C3 | none | 12.7% | 12.7% | 0.0% | 65.5% | 0.0% | 8.5% | 0.0% | 0.4% | 0.1% | 0 | 34.2% |
| C4 | none | 21.4% | 21.4% | 0.0% | 28.5% | 0.0% | 14.3% | 0.0% | 0.4% | 0.1% | 0 | 66.7% |
| C5 | none | 17.5% | 17.5% | 0.0% | 52.6% | 0.0% | 11.8% | 0.0% | 0.4% | 0.1% | 0 | 47.1% |
| C6 | none | 15.2% | 15.2% | 0.0% | 58.9% | 0.0% | 10.2% | 0.0% | 0.4% | 0.1% | 0 | 40.8% |
| E1 | none | 1.9% | 1.9% | 0.0% | 94.5% | 1.2% | 0.0% | 0.0% | 0.4% | 0.1% | 5.0% | 5.0% |
| E2 | none | 19.1% | 19.1% | 0.0% | 48.7% | 12.5% | 0.0% | 0.0% | 0.4% | 0.1% | 51.1% | 51.1% |
| E3 | none | 24.9% | 24.9% | 0.0% | 33.1% | 16.3% | 0.0% | 0.4% | 0.4% | 0.0% | 66.7% | 66.7% |
| E4 | none | 25.0% | 25.0% | 0.0% | 33.3% | 16.3% | 0.0% | 0.0% | 0.4% | 0.1% | 66.7% | 66.7% |
| E5 | none | 33.4% | 33.4% | 0.0% | 10.9% | 21.8% | 0.0% | 0.0% | 0.4% | 0.1% | 89.1% | 89.1% |
| E6 | none | 33.2% | 0.0% | 16.6% | 33.2% | 16.5% | 0.0% | 0.0% | 0.4% | 0.1% | 66.7% | 66.7% |
| E7 | Tissue 0.05 mm | 33.4% | 33.4% | 0.0% | 10.9% | 21.8% | 0.0% | 0.0% | 0.4% | 0.1% | 89.1% | 89.1% |
| E8 | Nylon 0.05 mm | 33.4% | 33.4% | 0.0% | 10.9% | 21.8% | 0.0% | 0.0% | 0.4% | 0.1% | 89.1% | 89.1% |

### Test Method 1. 180° Peel Adhesion

Peel adhesion is the force required to remove a coated flexible sheet material from a test panel measured at a specific angle and rate of removal. In the examples of this invention, the force is expressed in ounces per width of coated sheet (oz./in) and then converted to Newtons/cm. For cach test, a 0.5 in (1.27 cm) width of the adhesive coated sheet material approximately 5 inches (12.7 cm) long was cut and one of the release liners peeled away from the coated adhesive. One face of a standard float glass test panel was cleaned using isopropanol and lint-free wipers, and the adhesive strip was then applied to the clean face of the glass test panel. A heavy rubber roller was used to apply the strip. The free end of the coated strip was doubled back so that the angle of removal was 180 degrees. The free end was attached to the horizontal arm of the adhesion tester scale. The glass plate was then affixed to the platform of the instrument which is mechanized to move at a controlled rate (12 in/min) (30.48 cm/min) away from the scale. The peel test was started approximately 1 minute after the adhesive was applied to the substrate. The scale reading in ounces was read during the test as an average of both the peak and minimum forces during the peel. Three peel tests were run for each Example and averaged to yield the peel adhesion value. The results are summarized in Table 3.

The mode of failure was also record for each Example during the peel adhesion test and the results further summarized in Table 3, where “ad” indicates adhesive failure from the substrate and “co” indicates cohesive failure of the adhesive material.

### Test method 2. Work of Adhesion per Surface Area, With and Without Applied Electric Potential

The work of adhesion per surface area required to separate two parallel bonded test surfaces was measured while separating the surfaces in the through-thickness direction of the bonding material at a specific rate of removal.

The work of adhesion per surface area is expressed in Newtons per square centimeter of bonded surface multiplied by the travelled distance between plates in centimeters (units of N/cm). This was analyzed by integrating the area under the curve of tensile force in Newtons (N) plotted against the change in the gap between the bonded surfaces in centimeters (cm) and then dividing that value by the initial contact area in square centimeters (cm²) of the bonded test surfaces.

Testing was performed using a strain-controlled rheometer (ARES G2, from TA Instruments, New Castle, Delaware) equipped with an electrorheological accessory. Testing fixtures were 8-mm diameter stainless steel parallel plates. The bottom plate was attached to a water-cooled Advanced Peltier System (APS, from TA Instruments, New Castle, Delaware) for temperature control. Temperature was regulated at 25° C. for all adhesion tests. For application of the electric potential, an arbitrary waveform generator (33210A, from Keysight Technologies, Santa Rosa, California) was connected to a high voltage amplifier (Trek Model 609E-6, from Trek Inc., Lockport, New York) which was connected to the upper geometry on the rheometer. The lower geometry was grounded. This allowed the application of an electric potential in the range of 0 to ±4000 volts direct current (V DC) across a test specimen between the rheometer plates.

For each test, the 8-mm diameter parallel plate fixtures were attached to the rheometer and the gap between the plates was zeroed. An 8-mm diameter disk was cut from the single layer transfer adhesive (for C1-C6 and E1-E6) or the double-coated adhesive (for E7 and E8). One of the release liners was peeled away from the disk and the exposed adhesive applied to the clean surface of the lower 8-mm diameter stainless steel plate geometry of the rheometer. The second release liner was peeled away from the coated adhesive. Temperature was equilibrated at 25° C. for one minute. Then the upper plate was lowered to contact and compress the adhesive with a compressive load of 5 N for 500 seconds. During the compression step, a DC electric potential was applied during the final 100 seconds of compressive loading, at a voltage of either 0 V DC (as a control test) or −25 V DC. At the end of the compressive loading, the plates were separated at a rate of 0.001 cm/s, and the tensile force required to separate the plates was measured as a function of plate separation distance. Three tests were run for each condition for each Example and averaged to yield the work of adhesion per surface area values summarized in Table 3.

The percent (%) reduction in the work of adhesion per surface area was calculated by subtracting the respective average value with −25 V DC applied potential from the corresponding average value with no applied voltage, and then dividing that difference by the value with no applied voltage. A positive value for the % reduction indicates a reduction in the work of adhesion per surface area following application of the −25 V DC electric potential. These % reduction values for each of the Examples are also summarized in Table 3.

In the tested examples, negative DC electrical potentials resulted in preferential disbondment from the upper plate, while positive DC electrical potentials resulted in preferential disbondment from the lower (grounded) plate.

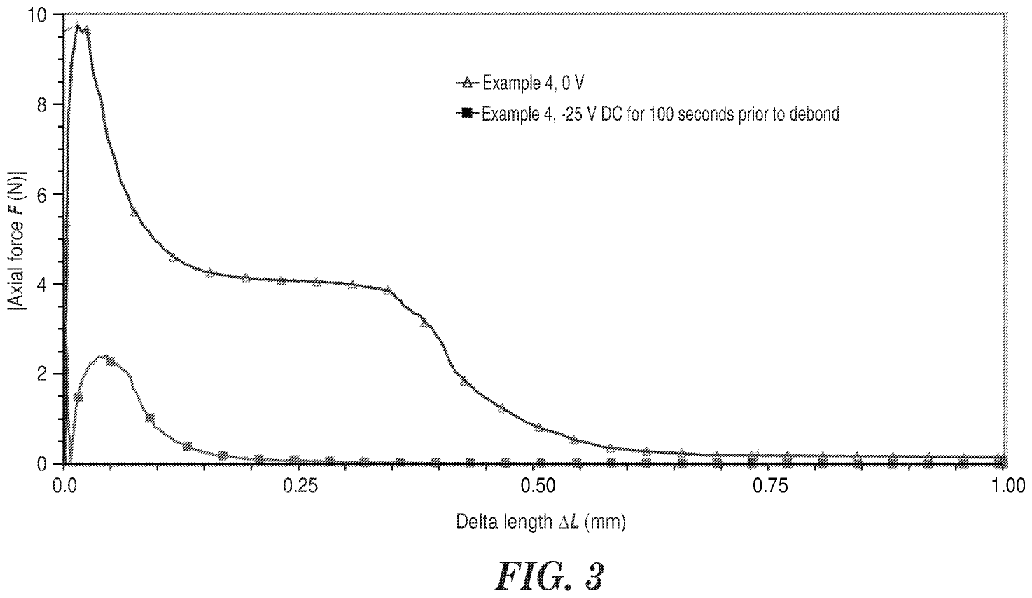

A tensile adhesion profile for Example E4 is illustrated in FIG. 3. The testing was done at 0 V and −25 V of DC electric potential applied during the final 100 second of the compression step. The tensile force in Newton is plotted on the y-axis and the distance between 8-mm diameter stainless steel parallel plates separated at a rate of 0.01 mm/second is plotted on the x-axis. Application of the electric potential decreases the bond strength of the adhesive as shown by a reduction in the work of adhesion (described by the area under the curve).

TABLE 3
Tensile Adhesion Results.

| | | | | Tensile Adhesion, Work of | | |
|---|---|---|---|---|---|---|
| | | 180° Peel from Glass @ | | Adhesion (N/cm) | | |
| | Caliper | 12 in/min (30.48 cm/min) | | | −25 V for | % |
| Ex. | μm | N/cm | Failure | 0 V | 100 s | reduction |
| C1 | 127 | 2.17 | ad | 0.335 | 0.250 | 25.4% |
| C2 | 127 | 0.27 | ad | 0.460 | 0.345 | 25.0% |
| C3 | 127 | 0.17 | ad | 0.078 | 0.003 | 95.9% |
| C4^{a, b} | 127 | 0 | co | * | * | * |
| C5^{a, b} | 127 | 0 | co | * | * | * |
| C6^{b} | 102 | 0.04 | ad | * | * | * |
| E1 | 127 | 4.00 | ad | 0.765 | 0.578 | 24.5% |
| E2 | 102 | 1.94 | ad | 0.229 | 0.115 | 49.6% |
| E3 | 114 | 1.39 | ad | 1.196 | 0.067 | 94.4% |
| E4 | 114 | 1.63 | ad | 0.372 | 0.039 | 89.5% |
| E5 | 114 | 0.89 | ad | 0.384 | 0.004 | 99.1% |
| E6 | 102 | 2.20 | ad | 0.305 | 0.176 | 42.3% |
| E7 | 80 | 2.63 | ad | 0.173 | 0.049 | 71.9% |
| E8 | 112 | 1.98 | ad | 0.359 | 0.003 | 99.2% |

^{a}Comparative Examples C4 and C5, when analyzed for 180° Peel Adhesion according to Test Method 1, showed cohesive failure with no measurable peel force.
^{b}Comparative Examples C4, C5 and C6 were not analyzed for Tensile Adhesion (Test Method 2) due to lack of adhesion to the testing surfaces.

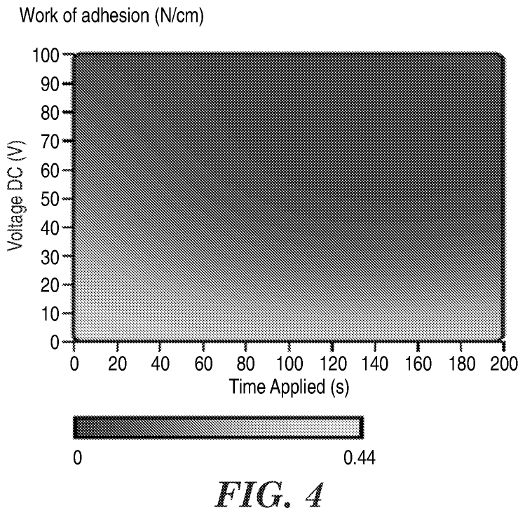

FIG. 4 shows a contour surface plot of work of adhesion per unit of surface area (denoted by the gray scale) from tensile adhesion testing of Example E2, as a function of applied DC voltage (y-axis) and the duration over which the voltage was applied prior to separating the plates (x-axis).

Thus, the present disclosure provides, among other things, articles containing adhesive compositions exhibiting on-demand debonding behavior. Various features and advantages of the present disclosure are set forth in the following claims.

1. An article comprising:
a first component having a first electrically conductive surface;
a second component having a second surface; and
an adhesive composition disposed between the first electrically conductive surface and the second surface, the adhesive composition comprising a cured polymerizable ionic liquid,
wherein the adhesive composition joins the first component to the second component,
wherein the effort required to separate the first component from the second component, as measured by work of adhesion per surface area, is reduced by application of a DC electric potential across the adhesive composition, and
wherein the polymerizable ionic liquid comprises
a polymerizable anion and a cation corresponding to the conjugate acid of the imidazole compound of Formula I 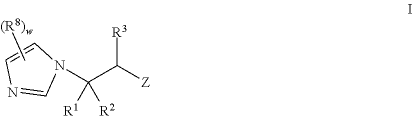
wherein
Z comprises a ketone, ester, amide, nitrile, or azlactone functional group,
R¹ is H or a C₁-C₂₅ alkyl group,
R² is H or —CO—X¹-R⁵, where R⁵ is a H or a C₁-C₂₅ alkyl group and X¹ is —O— or —NR⁶—, where R⁶ is H or a C₁-C₆ alkyl,
R³ is H or CH₃, preferably H, and
R⁸ is a (hetero)hydrocarbyl group which may be substituted at the 2-, 4- or 5-position, and w is 0, 1, 2 or 3,
with the proviso that when Z comprises a nitrile or azlactone functional group, then R¹ and R² are H.

2. The article of claim 1, wherein R¹ is H, R² is H, R³ is H, w is 0, and Z is an ester, and wherein Z is —C(O)—O—R¹⁰ and R¹⁰ is a hydrocarbyl group, said hydrocarbyl optionally substituted with a hydroxyl group.

3. (canceled)

4. The article of claim 1, wherein the polymerizable anion comprises an ethylenically unsaturated polymerizable group and an acidic group selected from a carboxylic acid group (—COOH), a sulfonic acid group (—SO₃H), a sulfate group (-—SO₄H), a phosphonic acid group (—PO₃H₂), a phosphate group (—OPO₃H), or a salts thereof.

5. (canceled)

6. The article of claim 1, wherein the polymerizable ionic liquid further comprises an optional monomer component, the optional monomer component comprising:
i. 60 to 99.5 wt % of an (meth)acrylic acid ester monomer;
ii. 0 to 30 wt % of a non-acidic functional, ethylenically unsaturated polar monomer; and
iii. 0 to 20 wt % of a multifunctional (meth)acrylate;
based upon the total weight of the optional monomer component, and
wherein the polymerizable ionic liquid comprises 2 to 75 wt % of the cation, 1 to 35 wt % of the polymerizable anion, and 5 to 95 wt % of the optional monomer component.

7-8. (canceled)

9. The article of claim 1, wherein the first component comprises a first nonconductive material and a first electrically conductive coating to provide the first electrically conductive surface.

10. The article of claim 1, wherein the second surface of the second component is a second electrically conductive surface.

11-12. (canceled)

13. The article of claim 10, wherein the composition of the first electrically conductive surface is different from the composition of the second electrically conductive surface.

14. (canceled)

15. The article of claim 10, wherein the adhesive composition is a two-sided adhesive comprising:
a carrier having a first major surface and a second major surface opposite the first major surface,
a first adhesive composition comprising a cured first polymerizable ionic liquid on the first major surface of the carrier, and
a second adhesive composition comprising a cured second polymerizable ionic liquid on the second major surface of the carrier,
wherein a surface of the first adhesive composition opposite the carrier is in contact with the first electrically conductive surface of the first component,
wherein a surface of the second adhesive composition opposite the carrier is in contact with the second surface of the second component, and
wherein each of the first and second polymerizable ionic liquids comprises
a polymerizable anion and a cation corresponding to the conjugate acid of the imidazole compound of Formula I 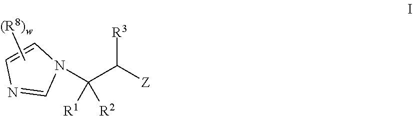
wherein
Z comprises a ketone, ester, amide, nitrile, or azlactone functional group,
R¹ is H or a C₁-C₂₅ alkyl group,
R² is H or —CO—X¹-R⁵, where R⁵ is a H or a C₁-C₂₅ alkyl group and X¹ is —O— or —NR⁶—, where R⁶ is H or a C₁-C₆ alkyl,
R³ is H or CH₃, preferably H, and
R⁸ is a (hetero)hydrocarbyl group which may be substituted at the 2-, 4- or 5-position, and w is 0, 1, 2 or 3,
with the proviso that when Z comprises a nitrile or azlactone functional group, then R¹ and R² are H.

16. The article of claim 15, wherein the carrier is a porous material.

17. (canceled)

18. The article of claim 15, wherein the carrier is an electrically conductive material.

19. (canceled)

20. The article of claim 15, wherein the composition of the first polymerizable ionic liquid is the same as the composition of the second polymerizable ionic liquid.

21. (canceled)

22. The article of claim 1, wherein the second surface of the second component is a nonconductive surface and the adhesive composition is a two-sided adhesive comprising:
a carrier having a first major surface and a second major surface opposite the first major surface,
a first adhesive composition comprising a cured first polymerizable ionic liquid on the first major surface of the carrier, and
a second adhesive composition comprising a cured second polymerizable ionic liquid on the second major surface of the carrier,
wherein a surface of the first adhesive composition opposite the carrier is in contact with the first electrically conductive surface of the first component,
wherein a surface of the second adhesive composition opposite the carrier is in contact with the second surface of the second component,
wherein the carrier is electrically conductive, and
wherein each of the first and second polymerizable ionic liquids comprises
a polymerizable anion and a cation corresponding to the conjugate acid of the imidazole compound of Formula I 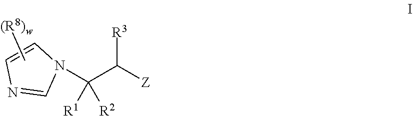
wherein
Z comprises a ketone, ester, amide, nitrile, or azlactone functional group,
R¹ is H or a C₁-C₂₅ alkyl group,
R² is H or —CO—X¹-R⁵, where R⁵ is a H or a C₁-C₂₅ alkyl group and X¹ is —O— or —NR⁶—, where R⁶ is H or a C₁-C₆ alkyl,
R³ is H or CH₃, preferably H, and
R⁸ is a (hetero)hydrocarbyl group which may be substituted at the 2-, 4- or 5-position, and w is 0, 1, 2 or 3,
with the proviso that when Z comprises a nitrile or azlactone functional group, then R¹ and R² are H.

23. The article of claim 22, wherein the carrier is a porous material.

24-26. (canceled)

27. The article claim 1, further comprising a first outer adhesive on a side of the first component opposite the adhesive composition, a second outer adhesive on a side of the second component opposite the adhesive composition, or a combination thereof.

28. The article of claim 27, wherein at least one of the first outer adhesive and second outer adhesive comprises a pressure sensitive adhesive.

29-31. (canceled)

32. The article of claim 1, wherein at least one of the first component and second component is a recyclable component.

33. The article of claim 1, wherein the effort required to separate the first component from the second component, as measured by the % change in work of adhesion per surface area at 0 V and −25 V for 100 seconds, is at least 20%.

34. A method for separating components in the article of claim 1, the method comprising applying the DC electric potential across the adhesive composition to separate the first component from the second component.

35. The method of claim 34, wherein the second surface of the second component is a second electrically conductive surface, the first electrically conductive surface or second electrically conductive surface serves as a negative electrode and the other of the first electrically conductive surface or second electrically conductive surface serves as a positive electrode, the method further comprising applying a DC electric potential so that the adhesive composition debonds from the negative electrode and causes separation of the first component from the second component.

36. The method of claim 34, wherein the adhesive composition is a two-sided adhesive comprising:
a carrier having a first major surface and a second major surface opposite the first major surface,
a first adhesive composition comprising a cured first polymerizable ionic liquid on the first major surface of the carrier, and
a second adhesive composition comprising a cured second polymerizable ionic liquid on the second major surface of the carrier,
wherein a surface of the first adhesive composition opposite the carrier is in contact with the first electrically conductive surface of the first component,
wherein a surface of the second adhesive composition opposite the carrier is in contact with the second surface of the second component,
wherein the carrier is electrically conductive,
wherein the first electrically conductive surface or carrier serves as a negative electrode and the other of the first electrically conductive surface or carrier serves as a positive electrode, and
wherein each of the first and second polymerizable ionic liquids comprises
a polymerizable anion and a cation corresponding to the conjugate acid of the imidazole compound of Formula I 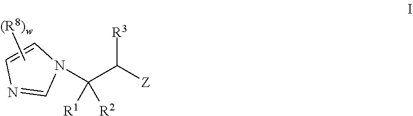
wherein
Z comprises a ketone, ester, amide, nitrile, or azlactone functional group,
R¹ is H or a C₁-C₂₅ alkyl group,
R² is H or —CO—X¹-R⁵, where R⁵ is a H or a C₁-C₂₅ alkyl group and X¹ is —O— or —NR⁶—, where R⁶ is H or a C₁-C₆ alkyl,
R³ is H or CH₃, preferably H, and
R⁸ is a (hetero)hydrocarbyl group which may be substituted at the 2-, 4- or 5-position, and w is 0, 1, 2 or 3,
with the proviso that when Z comprises a nitrile or azlactone functional group, then R¹ and R² are H,
the method further comprising applying a DC electric potential so that the adhesive composition debonds from the negative electrode and causes separation of the first component from the second component.

37-38. (canceled)
